(19) United States
(12) Patent Application Publication
(10) Pub. No.: US 2012/0282074 A1
(43) Pub. Date: Nov. 8, 2012

(54) APPARATUS AND METHOD FOR FORMING STACKS OF BAGS

(76) Inventors: Joerg Christian Thies, Dissen (DE); Heinz Berlin, Wennigsen (DE)

(21) Appl. No.: 13/509,081

(22) PCT Filed: Nov. 2, 2010
(86) PCT No.: PCT/EP2010/066648

§ 371 Date: Jul. 26, 2012

(30) Foreign Application Priority Data
Nov. 10, 2009 (DE) 10 2009 046 590.1

(51) Int. Cl. B65G 57/03

(52) U.S. Cl. 414/789.9

(57) ABSTRACT

The invention describes a device for forming stacks of bags, preferably bags of paper, which are individually supplied, comprising:
at least a first transport device with which individual bags are taken up,
a collection point to which the bags are fed by the transport device and in which a stack of bags can be produced,
a release device with which the bags are released from the transport device and dropped at the collection point,
   At least one separation device is provided which can be inserted into or above the stack at the collection point to divide the stack into a first and a second stack.

The invention relates to a device for forming stacks of bags according to the preamble of claim 1 and a method in accordance with the preamble of claim 8.

Bags are produced individually in an apparatus for producing bags. Plastic bags are usually provided with welds and usually separated at the same time. For the production of paper bags, first tubes are formed from sheets of paper and then pieces of the tube separated. A bottom is formed at the leading end of each piece of paper tube.

The bags so formed are stacked in an apparatus for forming stacks, so that the bags are removed in batches and packaged and/or processed further.

Such an apparatus for producing stacks is disclosed in published patent application DE 30 40 021 A1. A transport device is shown which fixes an individual bag from above to the lower run of a suction tape by means of a negative pressure and draws the bag towards a collection point. The bag is detached from the suction belt by means of a separation device while a pressing device presses the bag down at the collection point. The bag is detached from the suction openings of the suction tape. Once, a stack with a desired number of bags has been formed in this way, a conveyor belt on which the stack has been formed moves them on. Then, a new stack is formed at a free collection point of the conveyor belt.

The disadvantage of this arrangement is that the feed rate and thus the speed of the bag-making machine is very limited. If the feed rate is increased, the previous stack may not beat a sufficient distanced at the beginning of the forming of the new stack. This disadvantage is acceptable In the manufacture of foil bags because the production speed is limited by other factors.

However, in the manufacture of paper bags where speeds of over 1,000 bags per minute may occur, this limitation due to the said stacking limitation is undesirable.

DE 20 2007 002 477 U1, therefore, provides two collection facilities, but this arrangement leads to a large space demands and is also likely to be expensive.

The object of the present invention is, therefore, to propose a device and a method for forming stacks of bags where the stack forming speed is sufficiently high and the space requirements are minimal.

The object is achieved by a device according to the preamble of claim 1 and which, in addition, has the characterizing features of claim 1.

Accordingly, a separation device is provided that can be inserted into or above the stack at the collection point to divide the stack into a first and a second stack.

A separation device can be inserted at high speed into the stack or above the already formed stack. Preferably this separation device is inserted above the stack when the stack has reached the desired number of bags. The following bags are then placed above the separation device. Some of the bags lie on the separation device. The first stack formed in this manner, which is located below the separation device, can now be removed without significantly affecting the second stack being started above the separation device. As the insertion of the separation device can be effected within a few milliseconds, this process is usually completed before the first bag of the second stack reaches the collection point. The separation device does not need to cover the entire surface of a bag completely. It is sufficient when only one edge, preferably the leading edge in the direction of the transport of the bag, is covered.

It is particularly advantageous if the separation device comprises at least one holding device with which at least the lower bag of the second stack can be held. This holding device enables the newly-begun second stack to be fixed in position. In this way, the effect of the removal of the first stack is minimized.

In an advantageous embodiment of the invention, the separation device has at least one wedge-shaped finger. Such a wedge-shaped element can be inserted easily between two bags without any resultant problems. This form is advantageous when the first bag of the second stack has already dropped while the element is still moving.

In a preferred embodiment of the invention, the separation device has at least one hole subject to a negative pressure. This suction hole thus serves as a holding facility. This embodiment is useful because devices for bag making have a number of suction openings and there are, therefore, already means available for providing negative pressure, for example in the form of a vacuum pump.

Further embodiments of the invention are apparent from the description and the claims.

The individual figures show:

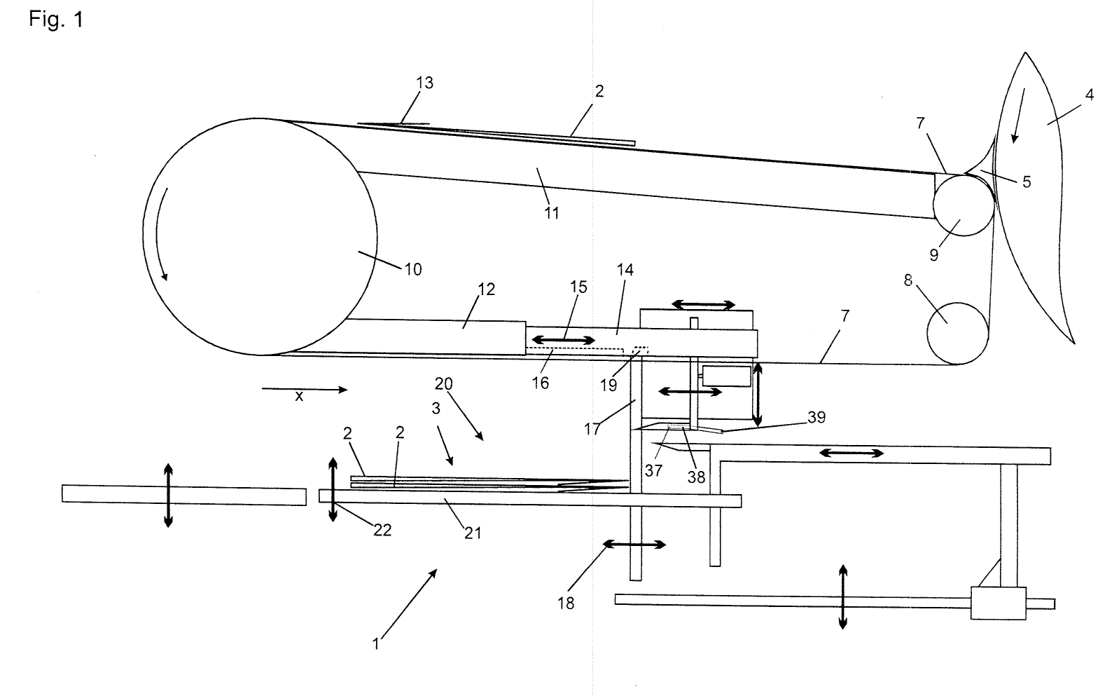

FIG. 1 Side view of a device according to the invention

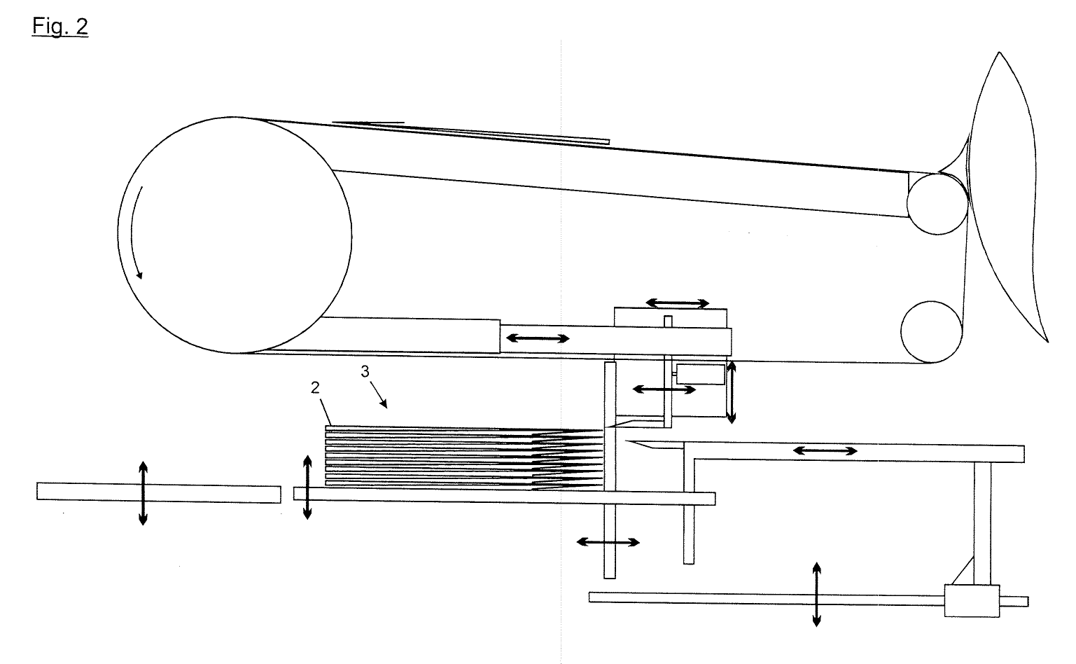

FIG. 2 Device according to FIG. 1 during formation of a first stack

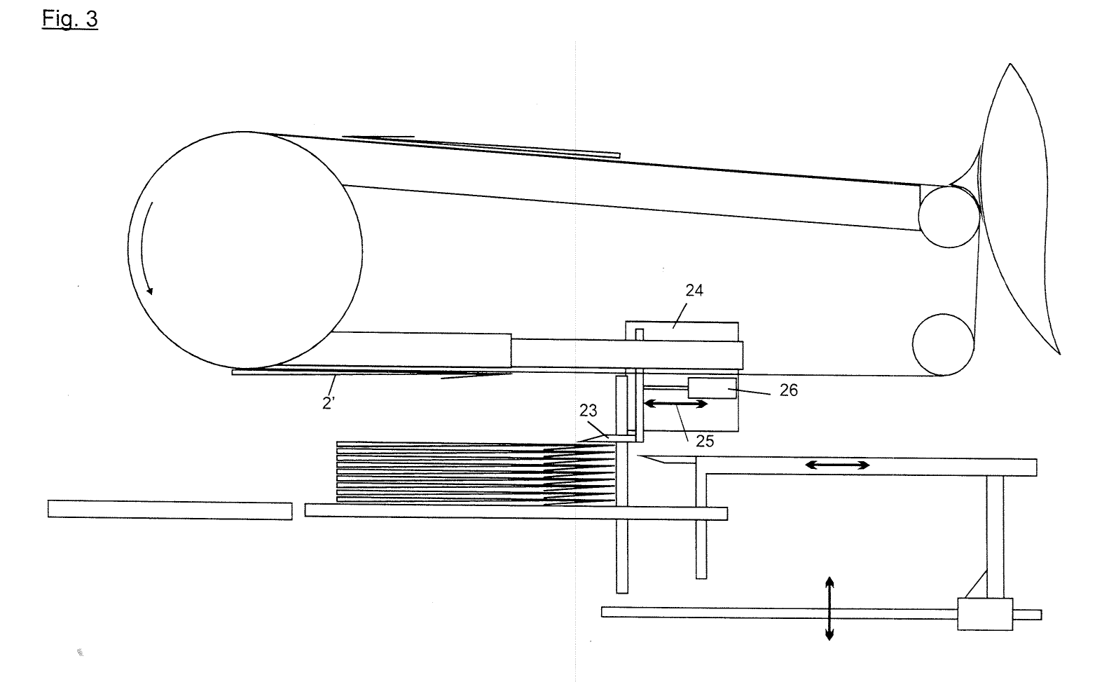

FIG. 3 Device according to FIG. 1 after insertion of a separation device

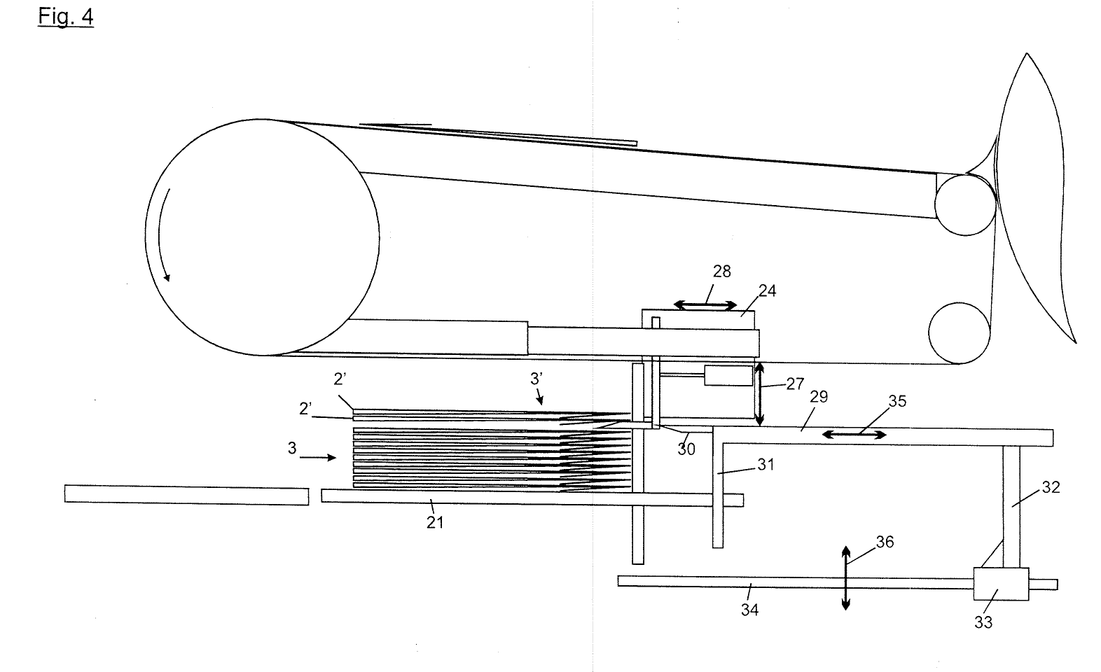

FIG. 4 Device according to FIG. 1 during formation of a second stack

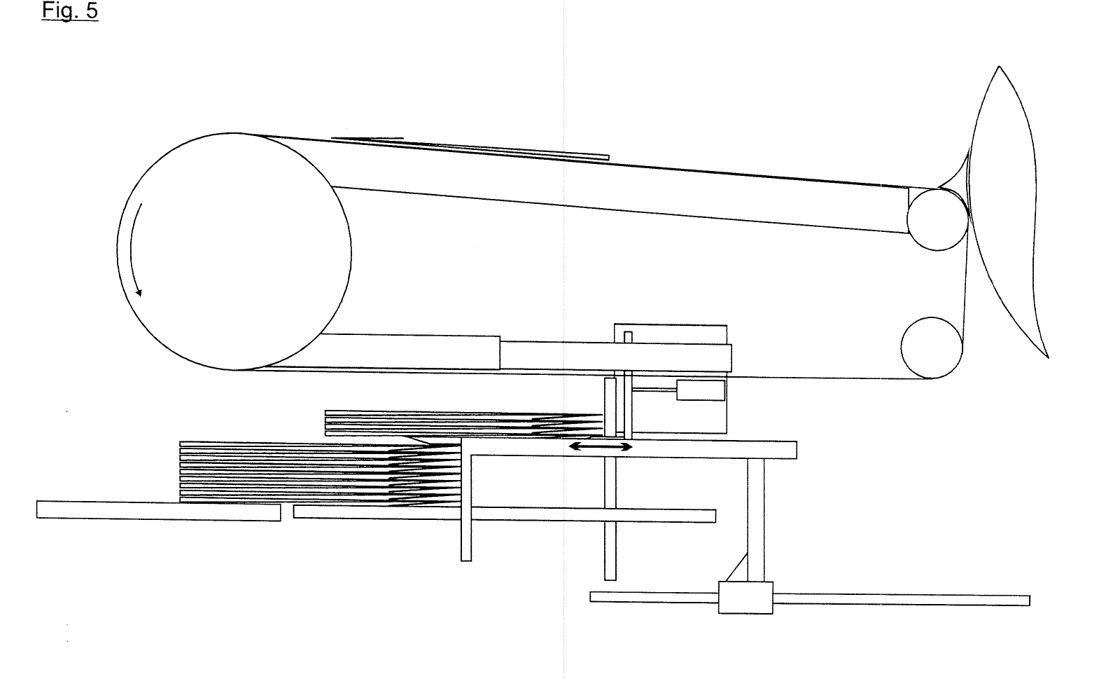

FIG. 5 Device according to FIG. 1 during removal of the first stack

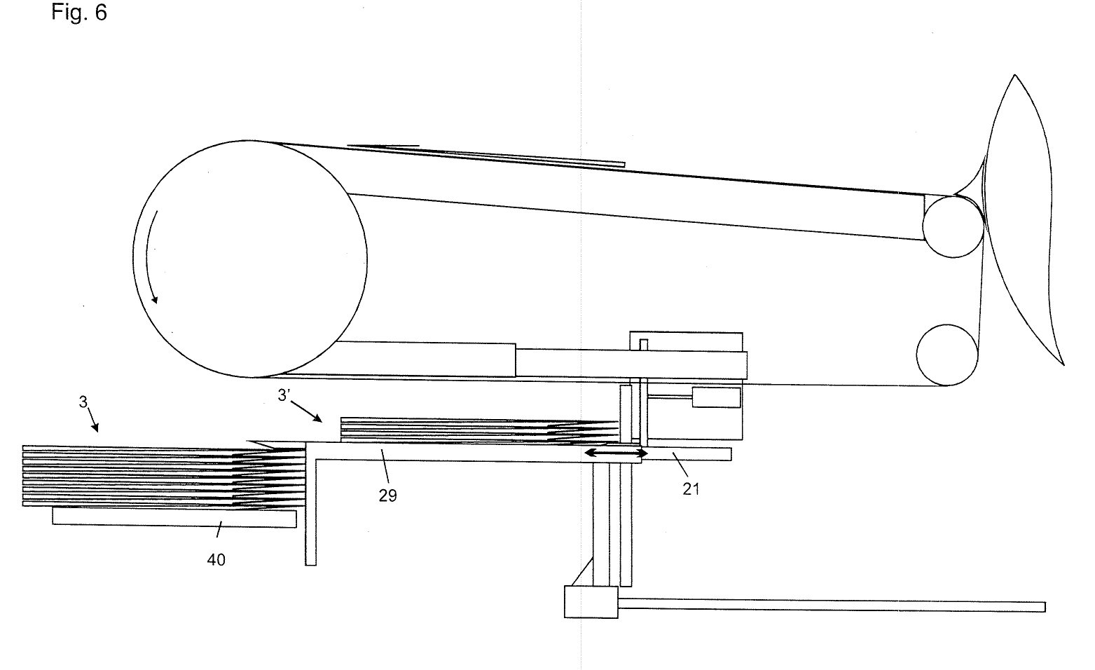

FIG. 6 Device according to FIG. 1 after the removal of the first stack

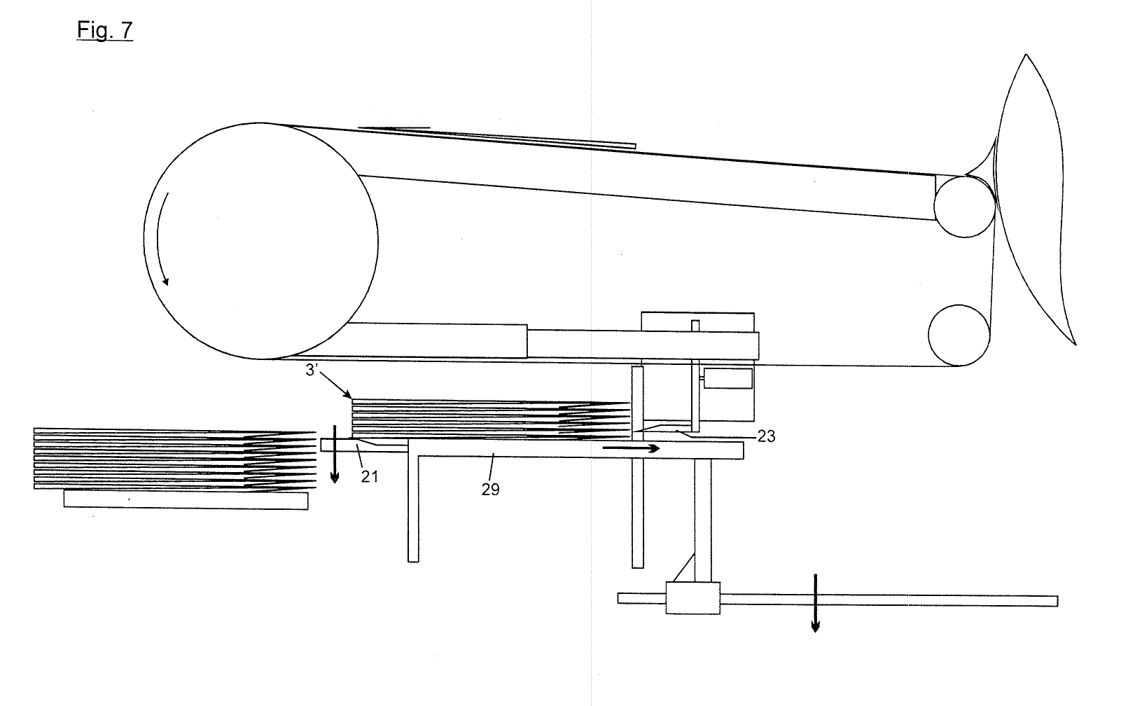

FIG. 7 Device according to FIG. 1 during the withdrawal of the slide.

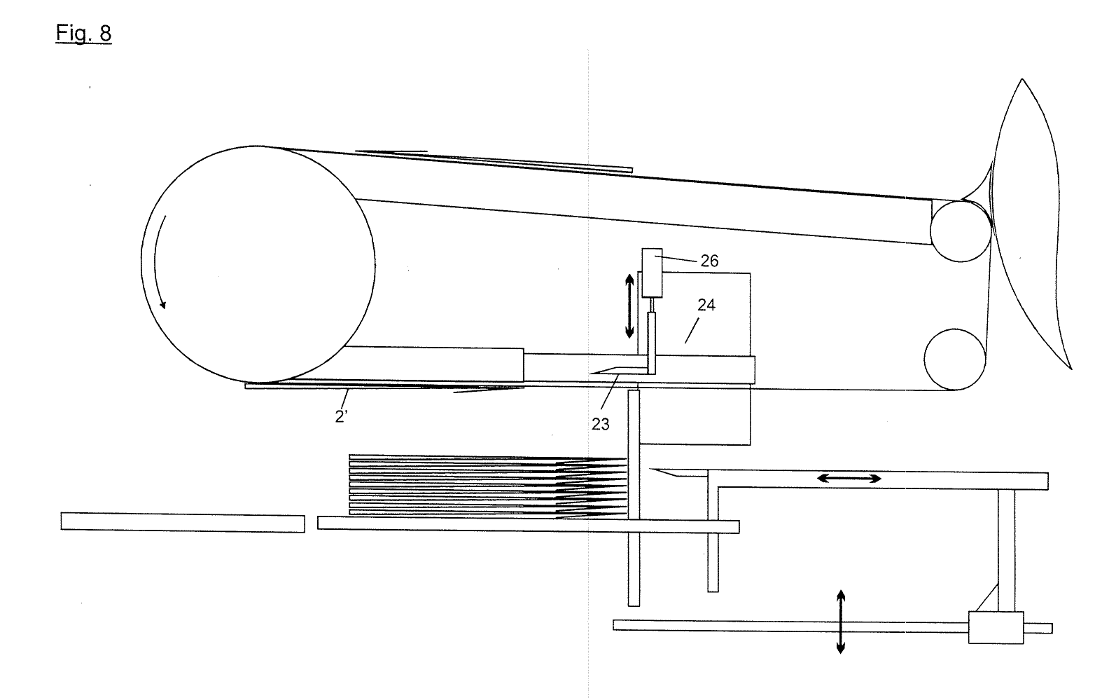

FIG. 8 Device with an alternate displacement direction of the separation device

FIG. 1 shows a device 1 according to the invention for forming stacks 3 of bags 2. These bags 2 are made in an apparatus for producing bags and the storage cylinder 4 is shown. The detachment finger 5 detaches individual bags from the storage cylinder and defects them onto the transport belt(s) 7 of the transport device 6. Each bag is transported with its folded end 13 leading. The folded end 13 thus forms the bottom and faces outwards, so that the bag with its rear side rests completely against the conveyor belt.

The transport device 6 comprises a number of adjacent conveyor belts 7 that rotate at the same speed. They run over the pulleys 8, 9, and 10, although more or fewer pulleys may be provided. The bag 2 can be fixed in various ways during the transport on the conveyor belt 7. One possible embodiment, using suction means of negative pressure, is already described in DE 30 40 021 A1. In this case, the conveyor belts have suction openings, whose respective distance is greater than the greatest length of the bags that can be produced by the bag machine. The transport belt 7 is guided over suction boxes 11, 12, each of which is connected to a vacuum source, although this is not shown in detail. The pulley 10 is also designed so that the suction openings of the conveyor belt 7 can be subjected to a negative pressure.

In order to be able to guide bags of variable length completely around the pulley 10, the suction box 12 has an extension 14 that is displaceable in the direction of the double arrow 15. The broken line shows the prolonging recess 16 of the groove of the suction box 12 (not shown). Therefore, as long as the suction opening of the conveyor belt 18 lies above this recess 16, the bag can be held. The release of the bag 2 is only possible at the end of the recess while the stop 17, which limits the transport path of the bag 2, is movable in the direction of the double arrow 18 by means of the extension 14. The stop 17 may be shaped like a rake or a fork that is able to pass between the individual conveyor belts 7. The extension 14 and the stop 17 are displaceable by means of a suitable adjusting device (not shown). This adjusting device may be in the form of a spindle/spindle nut combination that can be operated manually and/or by a motor, for example, an electric motor. Other adjustment arrangements are conceivable. The adjusting device can be mounted on a wall or column (not shown) of the machine frame.

In order not to damage the bag on release after removal of the negative pressure, the extension 14 comprises a further opening 19 which is pressurized with a positive pressure. Therefore, when the suction openings of the transport belt 7 pass this opening, the bags 2 are released properly.

The bags 2 thus conveyed and released at the stop 17 are deposited at the collection point 20 in a stack 3. The collection point 20 comprises a collection table 21 having a number of parallel ridges that are not shown in the illustration. These ridges pass through the stop 17. The collection table 21 is movable along the double arrow 22 and can, following each release of a bag, be moved downward by a small distance that is correlated with the thickness of the bag 2. In this way, a stack 3 of bags 2 is produced until it contains the desired number of bags. Such a situation is shown in FIG. 2.

In order to be able to start a new stack, the separation fingers 23 of the separation device can now be inserted above this stack in the area of the collection point 20. FIG. 3 shows the device after insertion of the separation fingers 23. For this purpose, the separation fingers 23 can be displaced by means of a holding device 24, for example a retaining plate. The displacement directions are indicated by the double arrow 25. A piston-cylinder unit may be provided as a displacement drive 26. However, any other kind of very fast acting actuator may be used. Linear motors would be also be of advantage here because of their speed and very high positioning accuracy. The displacement actuator 26 is supported on the holding device 24. The insertion of the separation finger 23 is effected so rapidly that the first succeeding bag 2′ can be released onto the separation fingers 23. In this way, the separation fingers separate the first completed stack from the newly-begun stack 3′.

With the growth of the stack 3′, the separation fingers 23 must also be simultaneously moved downward to the collection table 21. For this purpose, the holding plate 24 is displaceable in the vertical direction of movement as shown by the double arrow 27. Here, too, various suitable displacement means are conceivable. The holding plate can be operatively connected with the collection table 21 to enable common displacement. In this case, the holding plate and/or the separation fingers 23 with the sliding drive 26 must be displaceable with respect to the collection table in order to adjust to the desired stack height. However, this adjustment must only be carried out before production. In contrast, the displacement of the collection table and the holding plate takes place during bag production. Therefore, a motor-driven, precisely positioned displacement device is provided to this end. The holding plate 24 must be displaceable along the double arrow 28 synchronously with the stop 17 and/or the extension 14 in order to adapt to the bag length.

The first stack 3, which is now below stack 3′ that is being formed, can now be removed.

For this purpose, a slider 29 is provided, comprising a number of bars (only the front is visible). Positioning elements 31 are provided at right angles to the slider that take the form of a fork between the ridges of the collection table 21. The positioning elements 31 are still superposed by a wedge 30 or several wedges that can be inserted through the free space created by the separation fingers 23 between the stack 3 and the stack 3′. The slider 29 is supported on a support means 32 that is, in turn, connected to a carriage 33. This carriage 33 is shown along a rail assembly 34; in this case, the example here is of a single rail, sliding in the direction of the double arrow 35. The rail assembly is also displaceable in the direction of the double arrow 36 so that the vertical position of the slider 29 is adaptable to the position of the said free space. Following the adjustment to this position, which is shown in FIG. 4, the slider can be moved along the displacement direction 35. This is shown in FIG. 5. During the displacement process, the new stack 3′ is formed on the facing surface of the stack 3′. The slider can thus take over the function of the collection table 21 during this period.

It is essential that at least the lower bag of the stack 3′ can be held stable in its position with respect to the assembly 20 by means of a holding device so that the newly-begun stack 3′ is not displaced. Any displacement of the bags can result in a poor stack quality, which should be avoided. For this reason, in the illustrated embodiment, the separation finger 23 has openings 37 on the upper side which are subject to a negative pressure. This negative pressure can already be present when the first bag 2′ of the new stack 3′ rests on the separation finger 23. This can lead to an improvement in the quality of the stack 3′ during its formation. The opening 37 as well as the channels 38 and the suction line 39 are shown in FIG. 1. The holding means may, for example, be mechanical. One or more grips could seize at least the lower bag. Holding devices based on other physical operating principles are also conceivable.

Thus, an electrostatic attractive force can be used for such purposes. This is particularly applicable when the bag has, for example, a window made of a plastic material.

The stack 3 is moved by the slider against the transport direction x of the bag 2 shortly before its release. This direction points away from the separation fingers 23 so that the lower bag 2′ of the new stack 3′ is displaced and any damage avoided. The stack 3 is moved to a storage device 40 from which it can be further transported or removed. After the stack 3 has completely left the collection table 21, the latter is raised again and positioned under the lower bag of the new stack 3′. This situation is shown in FIG. 6. The stack 3′ now lies on the collection table 21, so that the separation fingers 23 can be brought back into the starting position, which is shown in FIG. 7. In addition, the slider 29 can be withdrawn to its starting position, so that now the situation is again produced according to FIG. 1.

The individually necessary components for the described method and described device can be arranged in various ways and can be optionally bonded to one another without departing from the inventive concept. In addition, the displacement devices mentioned as well as all of the necessary drives can be implemented in a variety of ways. Of particular note, however, is the use of linear motors, which allow quick displacements and very accurate positioning. Linear motors can be used for all the above-described displacement devices.

FIG. 8 shows a device in which the separation finger 23 is not horizontally but vertically displaceable. This is advantageous because during insertion of the separation finger, there is no risk of displacing the bag. In addition, the separation finger 23 can be moved on the release of the upper bag 2 of the stack 3 so that is not necessary to wait until the released bag lies completely on the stack. So this offers a time saving. In the upper position, the separation finger lies between or above the suction channels 12 and/or the extension 14 so that the formation of the stack 3 is not disturbed.

With the illustrated and described apparatus, therefore, stacks of bags with a desired number of bags can be produced and transported away, without the collection process in the apparatus being interrupted or having to be continued at a reduced speed.

### REFERENCE NUMERAL LIST

1 Device for forming stacks of bags

2 Bags

3 Stacks

4 Storage cylinder

5 Separation finger

6 Conveyor device

7 Conveyor belts

8 Pulley

9 Pulley

10 Pulley

11 Suction box

12 Suction box

13 Folded end of the bag 3

14 Extension of the suction box 12

15 Displacement device of the extension 14

16 Prolonged recess

17 Stop

18 Direction of movement of the stop 17

19 Opening

20 Collection table

21 Collection table

22 Movement direction of the collection table 21

23 Separation finger

24 Holding device

25 Double arrow

26 Displacement drive

27 Movement direction of the holding plate 24

28 Double arrow

29 Slider

30 Wedge

31 Positioning element

32 Support facility

33 Carriage

34 Rail arrangement

35 Displacement direction of the slider

36 Double arrow

37 Openings

38 Channel

39 Suction line

40 Storage facility

x Transport direction of the bag just before its release

1. Device for forming stacks (3) of bags (2), preferably of paper bags, which are individually supplied, comprising:
at least a first transport device (6) with which individual bags (2) are taken up,
a collection point (20) to which the bags (2) are fed by the transport device (6) and in which a stack (3) of bags (2) can be produced,
a release device with which the bags (2) are released from the transport device (6) and dropped at the collection point (20), where at least one separation device (23) is provided which can be inserted into or above the stack (3) at the collection point (20) to divide the stack into a first (3) and a second stack (3′) characterized in that
a slider (29) is provided, comprising a number of bars and positioning elements (31) at right angles to the slider (29) with which, after insertion of the separation device (23) removes the first stack (3) from the collection point (3) and whereby during the removal operation, the new stack can begin to be formed on the surface of the slider (29) facing the stack.

2. A device according to claim 1,
characterized in that
the positioning element is superposed by at least a wedge that can be inserted in the free space produced by the separation device (23) between the first stack (3) and the second stack (3′).

3. A device according to claim 2,
characterized in that
the separation device has at least one holding device with which at least the lower bag of the second stack can be held.

4. Device according to claim 1,
characterized in that
the separation device comprises at least one wedge-shaped finger.

5. Device according to claim 1,
characterized in that
the wedge-shaped fingers can be inserted above the first stack, before the first bag of the second stack can be dropped at the collection point.

6. Device according to claim 1,
characterized in that
the separation device comprises at least one hole that is subject to a negative pressure.

7. Device according to claim 1,
characterized in that
the separation device comprises at least one gripper.

8. Method for the formation of stacks of bags, preferably of paper bags, which are conveyed individually, whereby:
the individual bags are taken up by at least one first transport means,
the bags are fed by the transport device to a collection point where a stack of the bags is formed,
a release device with which the bags are released from the transport device and dropped at the collection point, where at least one separation device is provided which can be inserted into or above the stack at the collection point to divide the stack into a first and a second stack
characterized in that
a slider (29) is provided, comprising a number of bars and positioning elements (31) at right angles to the slider (29) with which, after insertion of the separation device (23) removes the first stack (3) from the collection point (3) and whereby during the removal operation, the new stack can begin to be formed on the surface of the slider (29) facing the stack.
